(19) United States
(12) Patent Application Publication
(10) Pub. No.: US 2012/0257051 A1
(43) Pub. Date: Oct. 11, 2012

(54) VERSATILE WIRELESS VIDEO AND VOICE MONITOR

(76) Inventors: Fred Cheng, Los Altos Hills, CA (US); Herman Yau, Palo Alto, CA (US)

(21) Appl. No.: 13/081,431

(22) Filed: Apr. 6, 2011

(51) Int. Cl. H04N 7/18

(52) U.S. Cl. 348/143; 348/E05.024

(57) ABSTRACT

A method for capturing data comprising at least one of video and audio from a camera comprising a transmitter and receiver integrated with the camera, wherein the camera outputs data to a first local device in a first communication format and wherein the camera simultaneously outputs data in a second different communication format.

### FIELD OF THE INVENTION

The present disclosure is directed to a camera for the capture of surveillance video and voice data. More particularly, the present disclosure is directed to a surveillance camera that can output data along two different communication formats to a local monitoring device and also to a router, which is connected to the Internet so the video and voice data can be shared with remote computing devices.

### BACKGROUND OF THE RELATED ART

Prior art surveillance applications are known in the art. The baby monitors are used to describe the operation of the prior art. Traditional baby video and/or voice monitor uses proprietary or analog-based RF scheme to wirelessly send the captured voice and video signals to a nearby local monitor.

A prior art (voice only Baby Monitor) configuration is shown in FIG. 1. The monitor system 10 includes a capturing unit 10-a and a monitoring unit 10-b. The capturing unit 10-a includes a pre-amplifier device and microphone A connected to a voice controller B, which is also connected to a voice amplifier C. The sound data is captured and amplified and then sent by the controller B to an RF module D. The RF module D is connected to an antenna E. The signal is communicated as shown to the antenna E of the monitoring unit 10-b and output via speaker F on the monitoring unit 10-v a short distance away. Certain designs may have the capability to allow a voice captured by the microphone A of the monitoring unit 10-b to be sent back to the capturing unit 10-a. The system is a closed loop application. It is low cost and easy to set up and operate. But the system is targeted for a local application such as within a household. It is very difficult to send such captured voice data to a far away remote site with such design.

FIG. 2 shows a second prior art's (a traditional video and voice baby monitor) system application diagram. The monitor 12 includes a capturing unit 12-a and a monitoring unit 12-b. The capturing unit 12-a includes a microphone and pre-amplifier device G connected to a controller H. The capturing unit 12-a includes a voice amplifier L connected to a speaker M. It also has a camera N connected to a controller K, which is connected to a controller H. The controller H is also connected to the voice amplifier L and the speaker M. The controller H is connected operatively to an RF module J, which is connected to an antenna E. The captured video and voice signals are then wirelessly sent through antenna E on the capturing unit 12-a to the antenna E on monitoring unit 12-b. A short distance away in the monitoring unit 12-b, a speaker M may output the captured voice and display the images using a LCD display L. Again, this configuration is very limiting in sending the captured signals to a far away place. The configuration cannot show images through Internet to a far away place and is limited to a household or the like.

FIG. 3 shows a Wireless Network IP Camera system connection and application diagram. Turning now to FIG. 3, recent introduction of the Wireless Network IP Camera 14 employs Wi-Fi® RF module 20 and uses an IP protocol to send the captured video data over computer networks. This device 14 includes a video camera 24 being connected to a controller 16. The controller 16 is connected to a video controller 18 and connected to a Wi-Fi module 20, which is connected to an antenna 22. The camera 14 is made for transmitting the captured video data to local viewer 32 over the router 26 or remote viewers 34 over the Internet 28. A remote user using a mobile communication device 34 can link device 34 to a Wi-Fi router 30 and can access an IP camera's output 14 as long as the camera's IP address is known to the user.

The drawback of such system is that the IP camera 14 are network devices which require networking and technical know-how to set up and operate, which makes it difficult to use for average consumers. Even for a local monitor service having a local monitor 32 being connected to a Wi-Fi router 26 to receive data from antenna 22 and the Wi-Fi module 20, a tedious set up on linking the local monitor 32 to a local Wi-Fi router 26 is still required. Besides, many of the Wireless Network IP Cameras 14 do not have any voice capturing capability. It is not even possible to build a local voice monitor with such camera. In most of the cases, it forbids the wide adoption of the camera for such application.

The prior art does not allow a user to capture video and audio with a video camera and have the video camera itself link to other devices. The prior art also does not allow a user to provide a convenient setup configuration to allow access to a Wi-Fi network and also to a local monitor at the same time so a user can easily receive voice and video data from the monitor. Generally, a user must link and configure each camera to a network one at a time, which can be time consuming.

### SUMMARY OF THE INVENTION

According to a first aspect of the present disclosure, there is provided a method. The method for capturing data comprising at least one of video and audio from a camera comprising a transmitter and receiver integrated with the camera, wherein the camera outputs data to a first local device in a first communication format and wherein the camera simultaneously outputs data in a second different communication format.

In yet another aspect of the present disclosure there is provided a wireless monitor comprising an image capture device for capturing video images, a transmitter and a receiver. The wireless monitor also has a circuit that communicates the video images to a local device via a first communication standard, and communicates the video images to a router via a second communication standard.

In another embodiment of the present disclosure, there is provided a baby monitoring device. The baby monitoring device comprises an image capture device for capturing digital video images, and a microphone for capturing audio data. The device also has an RF unit comprising a transmitter and a receiver that is connected to the image capture device and microphone. The RF unit communicates with a router for directing the captured video images and audio data to at least one of (i) a camera, (ii) a computing device, and (iii) a mobile communication device. The RF unit communicates the video and audio to a local monitor via a different communication standard

According to yet another embodiment of the present disclosure there is provided a method comprising: capturing data comprising digital video images and audio data; and outputting the captured video images and audio data to (i) a router at a first location and (ii) a local monitor.

According to yet another embodiment of the present disclosure there is provided a baby monitor comprising: an image capture device for capturing video images and a microphone for capturing audio data. The monitor also has a transmitter to transmit data to (i) a local monitoring device and (ii) to a wireless router for delivery of the video images and audio data to a remote computing device. The monitor also has a controller connected to the image capture device, the microphone and the transmitter.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a system diagram of a prior system for communicating signals via a radiofrequency module between monitors;

FIG. 2 shows a schematic of a prior art system of a monitor;

FIG. 3 shows a schematic of a system having a camera that communicates signals to a Wi-Fi router;

FIG. 4 shows a schematic of a versatile video and voice monitor communicating data to a local monitor and also to a remote location;

FIG. 5 shows a schematic of another embodiment of the versatile video and voice monitor communicating data to a local monitor and also to a remote location;

FIG. 6 shows a schematic of a number of versatile video and voice monitors communicating data to a local monitor and also to a remote location; and

FIG. 7 shows a number of method steps for communicating data to a local monitor and also to a remote location using different communication standards.

### DETAILED DESCRIPTION OF THE PREFERRED EMBODIMENTS

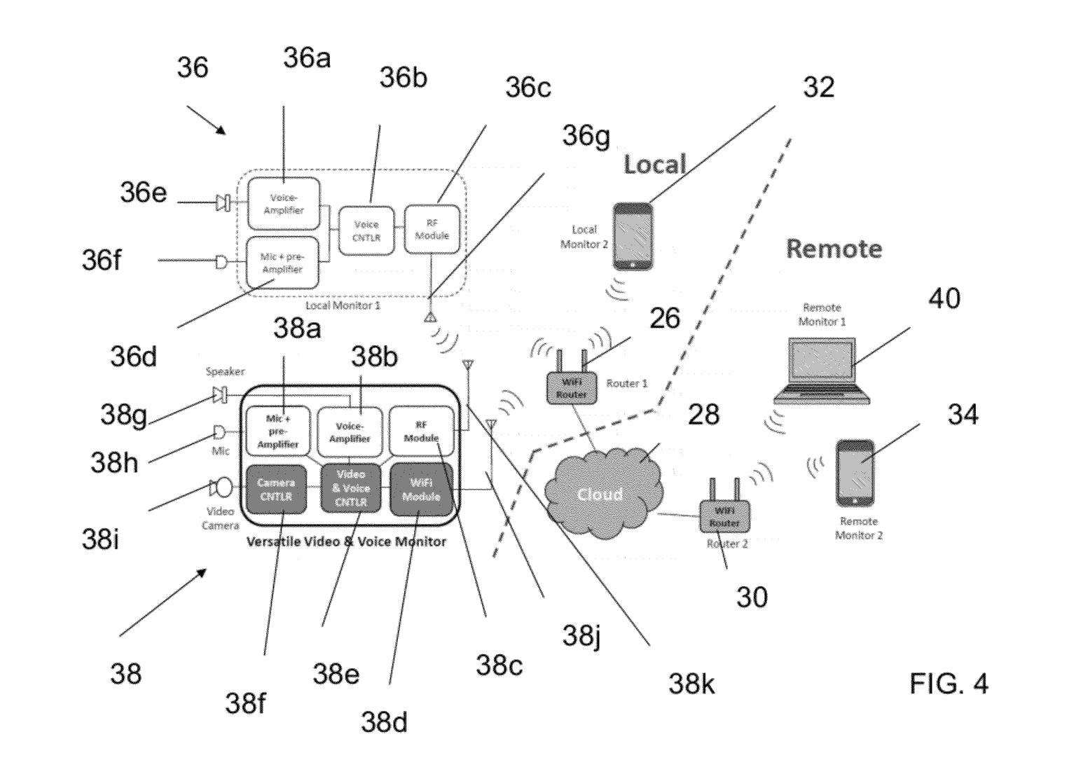

The present disclosure preferably is directed to a surveillance video camera 38i as shown in FIG. 4. The camera 38i is for capturing of surveillance data (video and audio) in a remote and continuous manner and supplying data to at least two locations. This provides with a very advantageous configuration whereby a mobile communication device 32 located close by can receive a feed of the camera 38i, and computing devices at a remote location 40, 34 can receive a feed of the camera 38i (together with other surveillance cameras) in an arrangement that is easier to install and can be installed cheaper than the prior art.

The monitor 38 preferably sends a first signal to a local monitoring device 36 and/or 32. The monitor 38 can send video or audio to the local monitoring device 36, 32. The monitor 38 also can send a second signal comprising video or audio to remote devices 40, 34. Furthermore, the remote and local devices 32, 36, 40 and 34 can also send video and audio to the monitor 38 for output at the monitor 38.

Turning now to FIG. 4, there is shown a versatile video and voice monitor of the present disclosure. The versatile video and voice monitor 38 preferably includes an RF module 38c and a Wi-Fi module 38d. The RF module 38c is connected to an antenna 38k and the Wi-Fi module 38d is connected to a second antenna 38j. Preferably, the RF module 38c and the Wi-Fi module 38d each include a transmitter/receiver or a transceiver to send and receive data. In another embodiment, a sole module may perform at least two different communication functions instead of having two modules 38d and 38c. The versatile video and voice monitor 38 comprises a microphone 38h connected to a microphone pre-amplifier device 38a, which is connected to a video and voice controller 38e. The versatile video and voice monitor 38 also comprises a video camera 38i, which is connected to a camera controller 38f, which is connected to video and voice controller 38e. The versatile video and voice monitor 38 also has a speaker 38g being connected to a voice amplifier 38b.

The versatile video and voice monitor 38 also has an RF module 38c connected to controller 38e and a Wi-Fi module 38d being connected to the controller 38e to receive control signals. In order to receive radio signals an antenna 38k is used. However, since the antenna will pick up thousands of radio signals at a time, a radio tuner is necessary to tune in to a particular frequency or frequency range via a resonator, or a circuit with a capacitor and an inductor forming a tuned circuit (not shown). The resonator amplifies oscillations within a particular frequency band, while reducing oscillations at other frequencies outside the band.

Preferably, the Wi-Fi module 38d is operable with connectivity technologies including wireless local area network (WLAN) based on the IEEE 802.11 standard. IEEE 802.11 is a set of standards carrying out wireless local area network (WLAN) computer communication in the 2.4, 3.6 and 5 GHz frequency bands. IEEE 802.11 is created and maintained by the IEEE LAN/MAN Standards Committee (IEEE 802), which is incorporated by reference in its entirety. The base current version of the standard is IEEE 802.11-2007. The controller 38e preferably comprises a digital signal processor that preferably outputs control signals to one or more components of the monitor 38. The memory (not shown) may be sufficient to record video and audio data for a predetermined period of time.

Camera 38i may have a video resolution of about 160×120, 320×240, and 640×480 or higher and the frame rate can be up to 30 fps with the video encoding being a MJPEG, MPEG4, H.264 or other video/audio compression algorithm. The camera 38i may also has image settings that include brightness, sharpness, contrast, white balance and a built-in microphone 38h or a standalone microphone 38h. Camera 38i may also have a 5V DC external power adapter with an operating temperature of preferably 0° C.˜40° C. (32° F. ˜104° F.) and an operating humidity of 20%˜80% (non-condensing of the lens).

The Wi-Fi module 38d communicates data to the antenna 38j, which is communicated to a Wi-Fi router 26 and modem (not shown). The Wi-Fi router 26 wirelessly receives signals from the camera 38i and Wi-Fi module 38d. The Wi-Fi router 26 preferably then transfers the data received by the Wi-Fi module 38d corresponding to the video and audio data to one or more destinations. In one aspect, the first destination may be a computer 40 connected to a second Wi-Fi router 30 (and modem), which is connected to the Internet 28. The computer 40 or 34 may be a laptop computer, a desktop computer (not shown), a net book computer, a mobile communication device, a remote monitor or a tablet computer as shown. At least one computer 40 or 34 preferably has requirements of a processor (not shown) of 1.4 GHz or above that can be operable with an operating system of APPLE® OSX of Apple Computers® of Cupertino, Calif., or MICROSOFT® WINDOWS® 7, or MICROSOFT® WINDOWS® VISTA®, or MICROSOFT®WINDOWS® XP® operable with a USB1.1/2.0 port and having about 256 MB RAM and 100 MB hard disk space. Various computer configurations are possible and within the scope of the present disclosure.

The second destination may further comprise a Wi-Fi router 30 that is connected a modem and connected to a computer 40. In this aspect, a user may view video and listen to audio data at the second destination from the wireless camera 38i at the first local destination. Also a user may have a mobile communication device 34 that receives wireless signals from a base station that is connected to the internet 28 to view video and listen to audio data at the second destination or from the router 30.

Additionally, a local monitor 36 is also provided. The local monitor 36 comprises a voice amplifier 36a that is connected to a voice controller 36b. The voice controller 36b is connected to an RF module 36c, which is connected to an antenna 36g. The local monitor 36 also has a microphone 36f, which is connected to a microphone preamplifier 36d, and which is connected to the controller 36b. Using the RF module 38c, the antenna 38k communicates data to the antenna 36g for local playback of data captured by the microphone 38h. A second local monitor 32 is also provided. Using the RF module 38d, the antenna 38j, Wi-Fi Router 26, the monitor 38 communicates data to the Local Monitor 32 for local playback of data captured by the microphone 38h.

In this manner, images and data can be captured by the monitor 38 and then communicated to (i) a local destination for playback of audio data via speaker 36e; (ii) communicated to a local Wi-Fi router 26, which is communicated to a local smart phone 32 for playback of audio and video using device 32; and (iii) communicated to a local Wi-Fi router 26, which is communicated to the internet 28 via modem and to a remote location. At the remote location, (iv) a computer 40 can output the captured video and audio using computing devices 40, which is connected to a second Wi-Fi router 30, which is connected to the Internet 28 via a modem (not shown). At the remote location, (v) a second computer or Smart Phone device 34 can output the captured video and audio of the monitor 38 using the speaker and display associated with the device 34. Further, local device 32 and monitor 36 can output data to the monitor 38 using the RF module 38c. Also, the remote computing devices 40 and 34 preferably can output video and audio to the monitor 38 via the routers 26 and 30 using a communication standard and using the module 38d.

The versatile video and voice monitor 38 thus incorporates two independent technologies into one device. The traditional proprietary or analog-RF-based Baby monitor is integrated with the Wireless Network IP Camera in one unit 38 as shown in FIG. 4. This implementation preserves the proprietary/analog channel (38c, 38k, 36g, 36c) to wirelessly send the video and/or voice data to a local monitoring device 36, while preserving the monitor's 38 ability to still send the video/audio data over the IP network through its Wi-Fi channel (38d, 38j) to the router 26.

The proprietary/analog RF channel enables a user to monitor activities in the local environment. The local monitor 36 shown in FIG. 4 is connected with the versatile voice and video monitor 38. So the traditional baby monitor function of transmitting voice/video data locally is preserved. The local monitor 36 can be an independent traditional baby monitor device. The second local monitor 32 on the other hand, can be a mobile communication device, a cell phone, a smart phone, an APPLE® I-PHONE® or the like, which can connect to the Wi-Fi router 26 or the Wi-Fi module 38d. Thus, the RF module 38c may communicate directly to device 36. The mobile communication device 32 can connect to the monitor 38 through an integrated Wi-Fi module. A user can watch the video and audio captured by the monitor 38 wirelessly through mobile communication device 32. So the mobile communication device 32 can become a wireless baby monitor by connecting through the local Wi-Fi router 26 as shown in FIG. 4. The mobile communication device 32 can provide the functionality of a second baby monitor for a local monitoring need.

The monitor 38 also provides a remote voice and remote video monitoring functionality. Both voice and video are routed into the voice and video controller 38e. The computing devices 40 and 34 located at the remote location can access to the monitor 38 through the Internet 28 and monitor's 38 IP address. Both voice and video signals are compressed and synchronized by standard video/audio compression algorithm such as H.264 or MPEG4, etc. The compressed signal is sent through Wi-Fi module 38d to the first Wi-Fi router 26. Data is then sent through the Internet 28 to the second router 30 and further to the remote computing devices 40 and 34, or more computing devices not shown herein. So in one embodiment, a plurality of devices 40 and 34 can become a remote video baby monitor 40 and 34 as shown in FIG. 4.

In one embodiment, the Smart Phone 34 (HTC® GOOGLE® ANDRIOD® PHONE, APPLE® I-PHONE®, BLACKBERRY® BOLD® etc) has both a microphone and a speaker (not shown). The remote user can see and hear the captured video and voice. The user can also talk back. The user can transmit audio to the Wi-Fi router 30. Data is then communicated to the Internet 28. Data is then sent to the Wi-Fi router 26. Data is then transmit to the antenna 38j and supplied to the monitor 38 and camera 38i at the local destination. A voice can be digitized and sent through Wi-Fi router 30, the Internet 28 to the Wi-Fi router 26 and output via the speaker 38g to reach the baby.

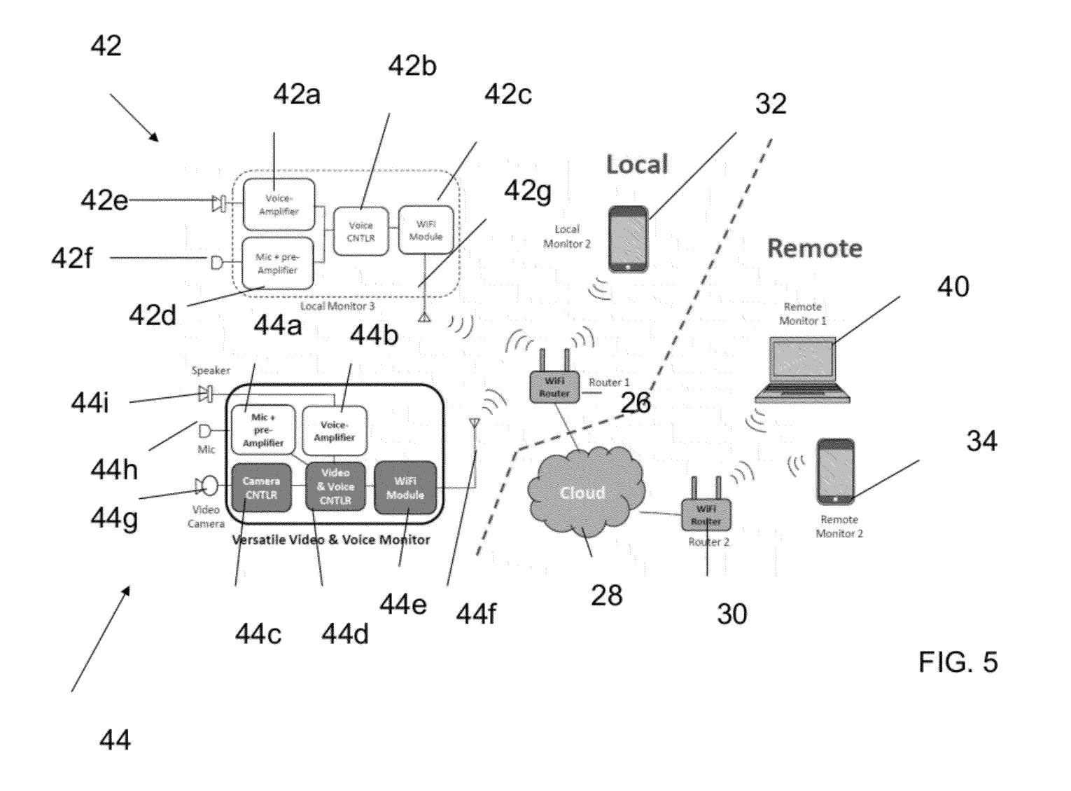

Turning now to FIG. 5, there is shown an alternative embodiment of the present disclosure. In a second embodiment, the RF module in both the monitor 44 and the local monitor 42 have been replaced with the Wi-Fi Modules generally shown as reference numeral 44e and 42c. Preferably, the local monitor 42 comprises a speaker 42e being connected to a voice amplifier module 42a and a microphone 42f being connected to a preamplifier module 42d.

The modules 42a and 42d are operatively connected to a controller 42b, which is connected to a Wi-Fi module 42c. The module 42c is connected to an antenna 42g. Preferably, the local monitor 42 uses a digital Wi-Fi module 42c to receive data. The local monitor 42 then outputs the data to the controller 42b, which outputs the amplified data via module 42a as sound to speaker 42e.

The monitor 44 is preferably a versatile video and voice monitor 44 and comprises a speaker 44i, a microphone 44h and a video camera 44g. The speaker 44i is connected to a voice amplifier module 44b. The microphone 44h is connected to the preamplifier 44a. The video camera 44g can be any video camera known in the art that is operable to output digital data and is connected to a controller 44c, which is connected to the video and voice controller 44d, and which is connected to the voice amplifier 44b.

The video and the voice controller 44d is connected to a Wi-Fi module 44e, which is connected to the antenna 44f. Contrasting this embodiment of FIG. 5 with FIG. 4, the versatile video and voice monitor 44 does not have any analog RF module. All the signals are transmitted through from the antenna 44f to the Wi-Fi router 26 and to the Wi-Fi module 42c in local monitor mode.

Wireless router 26 integrates a Wireless Access Point, Ethernet switch, and internal router firmware application that provide IP routing, NAT, and DNS forwarding through an integrated WAN-interface. Wireless router 26 allows wired and wireless Ethernet LAN devices to connect to a (usually) single WAN device such as a cable modem or a DSL modem. Wireless router 26 allows all three devices, mainly the access point and router, to be configured through one central utility. This utility is usually an integrated web server that is accessible to wired and wireless LAN clients and to WAN clients.

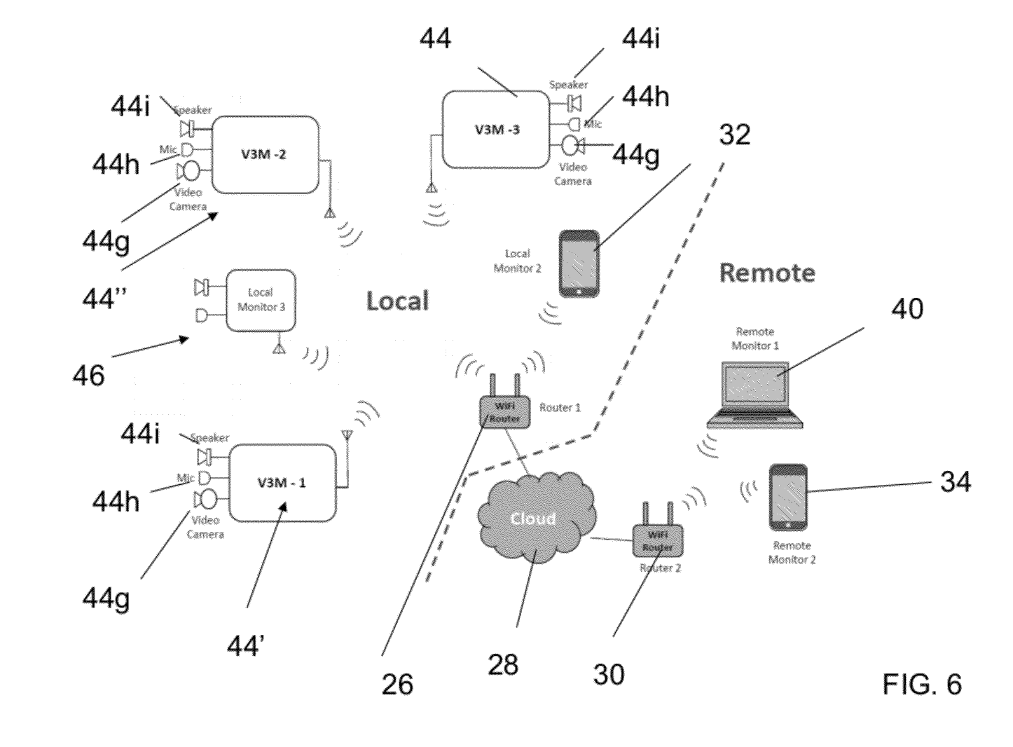

The versatile video and voice monitor 44 uses the local monitor 42 and the second local monitor 32 or Smart Phone 32 to operate as local monitors where a user can inspect sound or video. The remote computing devices 40 and 34 can access the video and voice signal data through from the versatile video and voice monitor 44 antenna 44f to the Wi-Fi router 26. The data is then communicated to the Internet 28 or network to the second Wi-Fi router 30, which is communicated to the remote computing devices 40 and 34. Turning now to FIG. 6, there is shown an alternative embodiment of the versatile video and voice monitor 44 of FIG. 5 being used in a local monitoring capability. A first through third versatile video and voice monitor 44, 44′, 44″ each having a speaker 44i, a microphone 44h and a video camera 44g can be accessed by their own specific IP address through the Wi-Fi router 26 and/or the Internet 28. The present first through third versatile video and voice monitors 44, 44′, 44″ have convenience of multiple angles to monitor a local site with both the local monitor mode as well as the remote monitor mode. Multiple users can access to each individual versatile video and voice monitors 44, 44′, 44″ to view the video image or voice signal of the monitored site or subject. The versatile video and voice monitors 44, 44′, 44″can be extended from a traditional baby monitor function to a more versatile function video and voice monitor and collect and aggregate surveillance data to a Smart Phone 32, and remote computing devices 40 and 34.

In an alternative embodiment, the RF module 38c shown in FIG. 4 may comprise a RF chip that includes a Wi-Fi Direct® feature. Wi-Fi Direct® is incorporated by reference in its entirety, formerly known as Wi-Fi Peer-to-Peer®, is a set of software protocols that allow Wi-Fi devices to talk to each other without prior setup or the need for wireless access points (hot spots). Wi-Fi®Direct® allows the construction of ad-hoc networks between computers, or more commonly, computers and peripherals like printers. Wi-Fi®Direct® is developed and supported by the Wi-Fi®Alliance, the industry group that develops the Wi-Fi® CERTIFIED® standards suite.

The remote computing devices 40 and 34 can be a mobile phone, a notebook computer, an iPhone® or iPad® tablet device manufactured by Apple® Corporation, a net book computer, a BLACKBERRY® communication device manufactured by Research in Motion Corporation®, a MOTOROLA® DROID® communication device or a communication device operable with the HTC® GOOGLE® ANDRIOD® configuration, or another mobile communication device. Once connected, the user operating with the mobile device may receive digital data from a video stream directly from the versatile video and voice monitors 44-44′″ shown in FIG. 6.

In this manner, a remote user can monitor the target and the data output from the cameras 44g from a remote location in real time. Alternatively, the camera 44g may be connected to a Wi-Fi dongle, 3G Modem or be connected to a 3G cellular phone. In this manner, each of the wireless surveillance cameras 44g transmit the video data to a remote monitoring site such as SEEDONK® VIDEO MANAGEMENT sharing software platform for other desirable applications via the internet 28.

The monitors 44-44″ may be preconfigured to skip the on-site set up procedural work. In this manner, the desired monitors 44-44″ can automatically find the Wi-Fi router 26 and then connect to a 3G cellular dongle or modem or other broadband service for Internet connection. This feature enables quick setup and installation of a remote video monitoring system without any prior cable wiring and broadband service set up to each and every camera. This can be easily implemented with minimum equipment costs and can be set up by an individual with minimal training.

In one embodiment, the Wi-Fi router 26 and 30 are connected via a modem, which can be a 3G modem that is operable with a wireless communication network, such as GSM, CDMA, or the like (for example, modem can be a Sprint® 3G/4G USB Modem U300). In another embodiment, the modem may be a 4G modem. In a further embodiment, the modem can be operable with Wi-Max or the like.

Various modem configurations are possible and within the scope of the present disclosure and modem is intended to be any modem that connects to a wireless network and that attaches directly to a wireless ISP (Internet Service Provider) via base station, which is connected to the Internet 28. 3G refers to the International Mobile Telecommunications-2000 (IMT-2000) or the 3rd Generation standards for mobile telecommunications defined by the International Telecommunication Union. 3G preferably includes at least one of GSM, EDGE, UMTS, and CDMA 2000 as well as Time Division Synchronous Code Division Multiple Access (“TD-SCDMA”), Digital Enhanced Cordless Telecommunications (“DECT”) and Wi-MAX®. 3G may further include a wide-area wireless voice telephone, video calls, and wireless data, all in a mobile environment that allows simultaneous use of speech and data services and higher data rates of up to about 14.0 Mbit/s on the downlink and about 5.8 Mbit/s on the uplink.

The first through third digital video cameras 44g are preferably cameras that take video or still photographs, or both, digitally by recording images via an electronic image sensor. The first through third digital video cameras 44g may also include a night vision feature to record data and may include infrared light emitting diodes with auto activation and with a video resolution of about 640×480. The first through third digital video cameras 44g can be closed-circuit television cameras, generally used for security, surveillance, and/or monitoring purposes. The first through third digital video cameras 44g can be small, easily hidden, and able to operate unattended for monitoring a predetermined area for long periods of time. For example, the first through third digital video cameras 44g can be webcams operable for use as a closed circuit television camera and each may convert a signal from the electronic image sensor directly to a digital output and can incorporate a circuit to directly interface with a specific protocol.

Alternatively, instead of the Smart Phone computer 32 shown in FIG. 6, the first through third digital video cameras 44g can interface and output a digital signal to a different device. For example, the computer 32 may be a laptop computer, a tablet, a desktop, a BLACKBERRY® communication device or mobile phone, an APPLE® I-PHONE®, APPLE® I-POD® or IPAD®, a mobile phone, an e-Book Reader, or other device such as a computer or communications hardware, a net-book, a desktop, or a predetermined models of laptop computers. The digital video may be H.261, H.263, H.264, JPEG, MJPEG, MPEG or any other digital video formats known in the art.

Another path continues from the Internet 28 to a router 30, where the data is transmitted in a wireless manner along wireless signal to a remote destination and to a remote computing device or communication device. In this manner, the remote users may both view the output of the surveillance camera 44g of each monitor 44, 44′, and 44″. In one aspect, the remote users 34 and 40 may access the data via a software program or platform that is installed at the computer 40 or the computer 34 or installed and run on the Internet 28 in a cloud computing configuration.

The software platform preferably can be a SEEDONK® Video Management platform. The software platform can be a video monitoring and a video sharing application and is a consumer platform for viewing, managing and sharing cameras over the Internet 28. Devices 34 and 40 form no limitations to the present disclosure and are merely illustrative of one non-limiting embodiment. For example, using the software platform, the user can be authenticated for access. Thereafter, the user may then view the output of the digital video camera 44g and video and audio data. The user may then also use the prompts associated with the software platform to control the digital video camera 44g to pan, tilt, zoom or perform any other control functions associated with the digital cameras 44g and also send messages to other users.

Preferably, the computer 40 and 34 may control the specific digital camera 44g to initiate the display of the video data of the target, to magnify an image of the target, or to record the data or adjust any and all settings of one or more cameras 44g. Moreover, the computer 40 and 34 may also send a control signal to specific digital camera 44g to pan, tilt, and zoom.

A video processing operation may be performed on the data prior to sending the data from the first destination to the second destination or prior to sending the data from camera 44g to computer 40 and 34. For example, data may be compressed prior to sending the data from the first destination to the second destination. Frames may be removed from the images that are redundant prior to transmitting the data from the first destination to the second destination. Various data rate configurations are possible and within the scope of the present disclosure. It should be appreciated that the video compression may even permit the transfer of video over a relatively small bandwidth. For example, each camera 44g may embed or incorporate data into the captured video image. The embed data can be text such as the day, hour, minute, second, camera identification information (Camera 1, Camera 2, etc.), alarm, object presence, event data, or any other identification data known in the art. Metadata may also be incorporated into the captured video image.

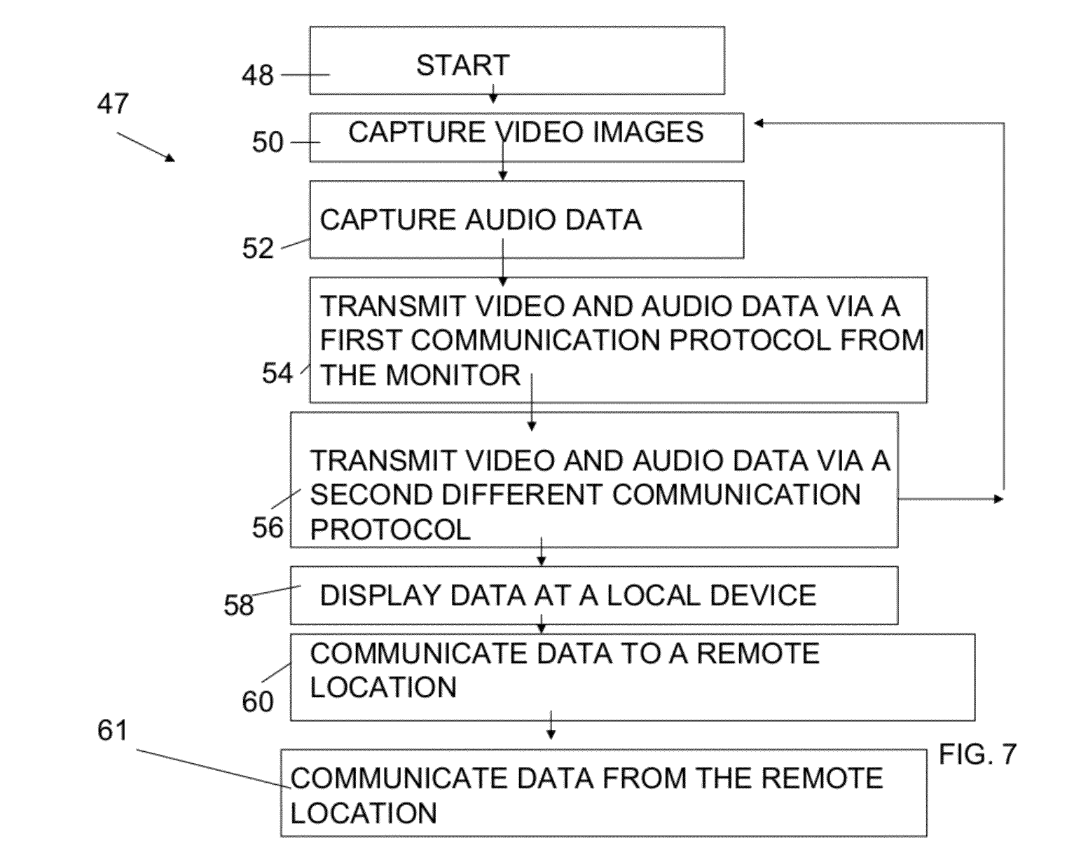

Turning now to FIG. 7, there is shown a method 47 according to one embodiment of the present disclosure. The method 47 commences at step 48 and passes to step 50 to capture video images. The method 47 then passes to step 52 to capture audio data and passes to step 54. At step 54, the method 47 transmits video and audio data via a camera and a microphone on a monitor via a first communication protocol. At step 56, the method 47 then transmits the video and audio from the monitor via a second different communication protocol. Then at step 56, the data is displayed and output at a local device. At step 60, the data can be routed and then displayed and output to a remote device. Optionally, the remote device can communicate data to the local location (step 61).

It should be also appreciated that the method steps are not limited to the hierarchal order shown and some steps can be performed before others and some steps can be performed simultaneously. Various configurations of the present method are possible and within the scope of the present disclosure.

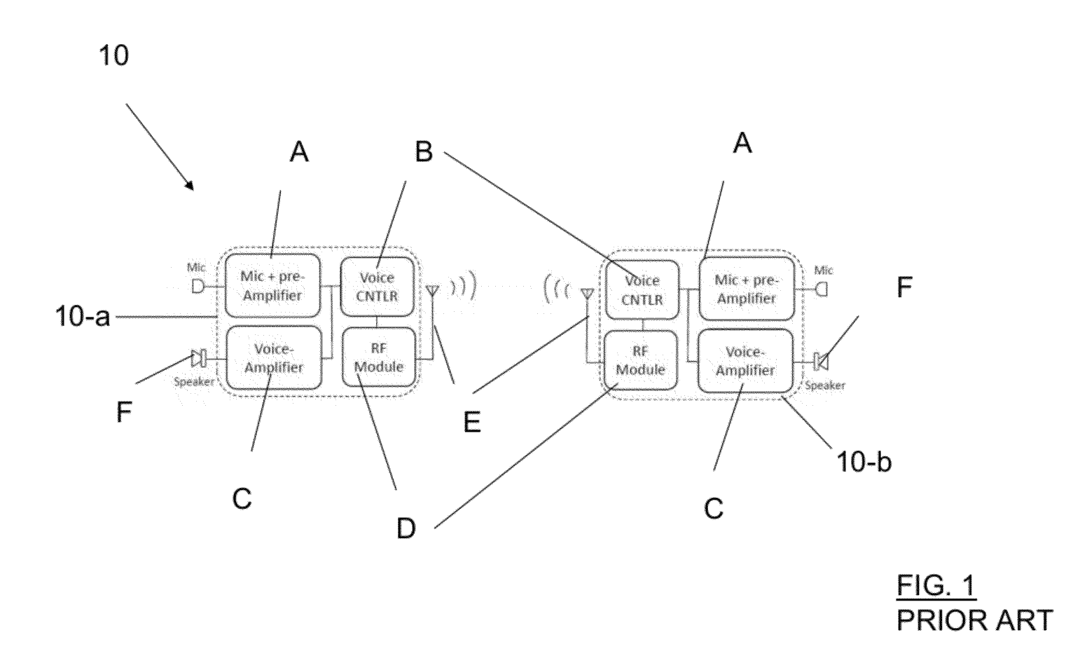

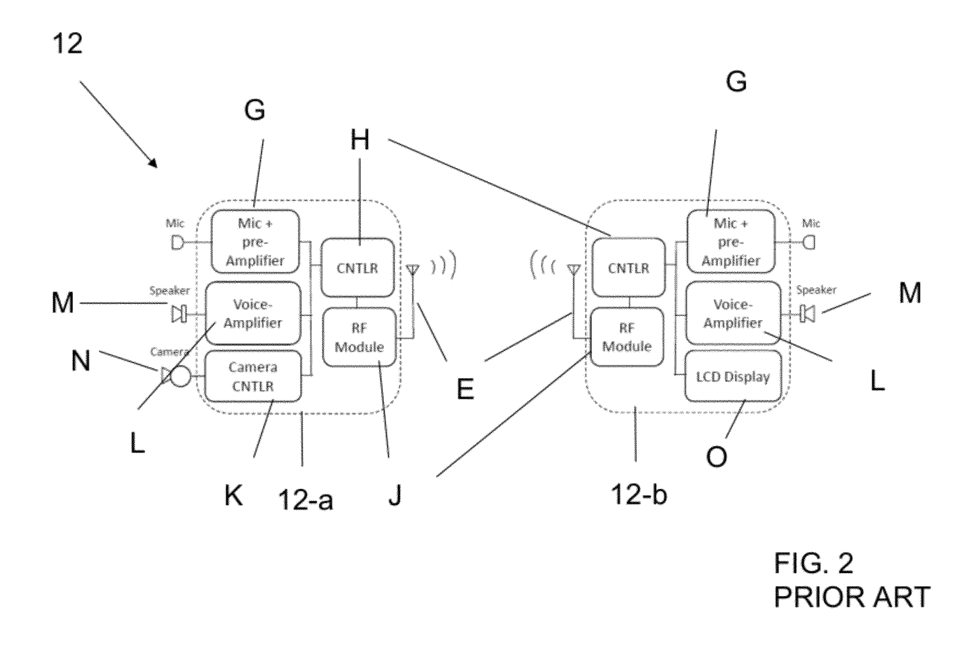

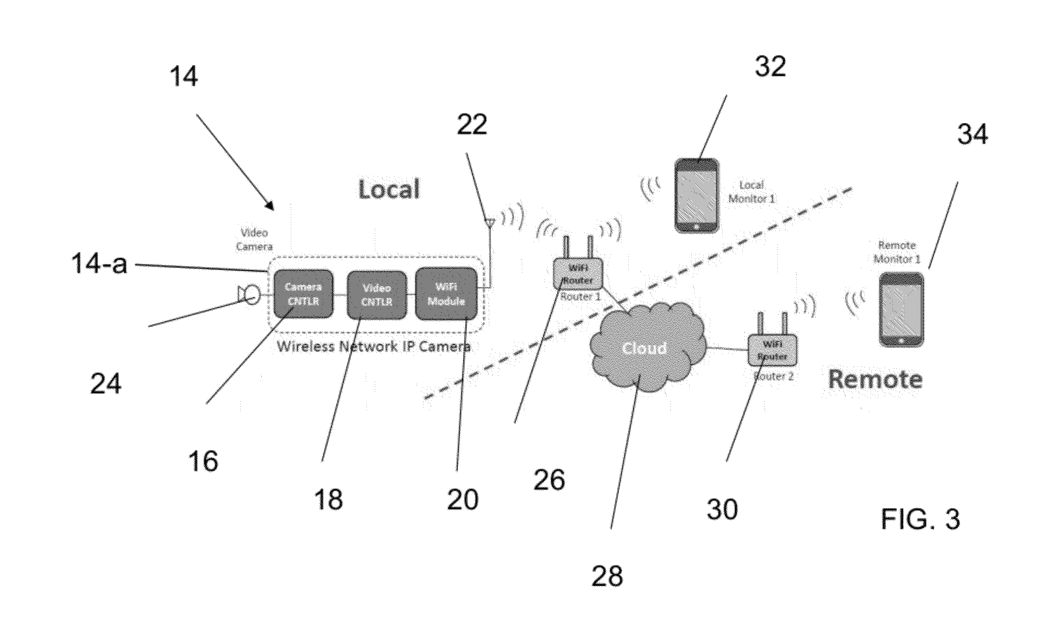

Generally, in operation, the computer system operable with that method shown in FIGS. 1-7 is controlled by an operating system. Typical examples of operating systems are MS-DOS, Windows95, 98, 2000, XP, Vista and Windows 7 from Microsoft Corporation, or Solaris and SunOS from Sun Microsystems, Inc., UNIX based operating systems, LINUX based operating systems, or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A method comprising:
capturing data comprising at least one of video and audio from a camera comprising a transmitter and receiver integrated with the camera, wherein the camera outputs data to a first local device in a first communication format and wherein the camera simultaneously outputs data in a second different communication format.

2. The method of claim 1, wherein the first local device is a baby monitor.

3. The method of claim 1, further comprising transmitting the data using a Wi-Fi communication format.

4. The method of claim 1, further comprising transmitting the data to a computing device.

5. The method of claim 1, wherein the first format is a proprietary/analog channel to wirelessly send the video and/or voice data to a local monitoring device.

6. The method of claim 1, wherein the second communication format transmits video/audio data over an IP network through a WiFi channel.

7. The method of claim 1, further comprising transmitting the data to a second destination by a router connected to the internet.

8. The method of claim 1, further comprising transmitting the data to the second destination by a computing device connected to a router that is connected to the Internet.

9. The method of claim 1, further comprising transmitting the data to the second destination by the computing device connected to the network router that is connected to the Internet, and communicating the data to a second network router to a second computing device.

10. The method of claim 1, further comprising communicating the data to a base station and to a second portable device for viewing the data comprising video and listening to the data comprising audio on the second portable device.

11. The method of claim 1, further comprising communicating the data to a router and to the Internet and to at least one of (i) a base station, or (ii) a router and to a (i) mobile device or (ii) a computing device located at the second destination.

12. The method of claim 1, wherein the camera captures images and audio and communicates the images and audio to a local monitor and also communicates the images and audio to a second device.

13. A wireless monitor comprising:
an image capture device for capturing video images;
a transmitter;
a receiver; and
a circuit that communicates the video images to a local device via a first communication standard, and communicates the video images to a router via a second communication standard.

14. The wireless monitor of claim 13, further comprising a microphone and wherein the wireless monitor captures video and audio and transmits the video and audio via the transmitter.

15. The wireless monitor of claim 13, wherein the router is connected to the internet and communicates the video images to a second computing device at a second location.

15. The wireless monitor of claim 13, further comprising a video camera that is a pan, tilt, zoom camera.

16. The wireless monitor of claim 13, wherein the image capture device captures video and audio, and wherein the wireless monitor transmits the video and audio in a digital signal.

17. The wireless monitor of claim 13, further comprising a memory for recording the data.

18. The wireless monitor of claim 13, wherein the wireless monitor is wirelessly connected to at least one of (i) a baby monitor and the router that is connected to the internet, (ii) a wireless modem that is connected to the internet, or (iii) a device wirelessly connected to the internet.

19. The wireless monitor of claim 13, wherein the image capture device is connected to the router, and the router is connected to the internet for providing the images to a mobile communication device, and wherein video and audio data captured by the image capture device is output for display on the mobile communication device, and wherein the mobile communication device is wirelessly connected to the internet.

20. The wireless monitor of claim 13, wherein the transmitter and receiver are located in an RF module integrated within the wireless monitor.

21. A baby monitoring device comprising:
an image capture device for capturing digital video images, and a microphone for capturing audio data; and
an RF unit comprising a transmitter and a receiver that is connected to the image capture device and microphone, the RF unit communicating with a router for directing the captured video images and audio data to at least one of (i) a camera, (ii) a computing device, and (iii) a mobile communication device; and
a module for communicates the video and audio to a local monitor via a different communication standard.

22. A method comprising:
capturing data comprising digital video images and audio data; and
outputting the captured video images and audio data to (i) a router at a first location and (ii) a local monitor.

23. The method of claim 22, wherein the router and the local monitor receive the images and audio data from a same communication format.

24. The method of claim 22, wherein the router and the local monitor receive the images and the audio data from a different communication format.

25. The method of claim 22, wherein the router is connected to the internet and wherein at least two computing devices connected to the internet receive the images and audio data for display and output.

26. The method of claim 22, wherein the output captured video images and audio data is output by an antenna.

27. The method of claim 22, wherein the output captured video images and audio data is output by a plurality of antennas.

28. The method of claim 22, further comprising amplifying the audio data.

29. The method of claim 22, further comprising outputting the captured video images and audio data to the local monitor comprising a mobile communication device.

30. A baby monitor comprising:
an image capture device for capturing video images;
a microphone for capturing audio data;
a transmitter to transmit data to (i) a local monitoring device and (ii) to a wireless router for delivery of the video images and audio data to a remote computing device; and
a controller being connected to the image capture device, the microphone and the transmitter.

31. The baby monitor of claim 30, further comprising: an amplifier being connected to the microphone.

32. The baby monitor of claim 30, further comprising a controller being connected to an amplifier, wherein the amplifier is connected to the microphone.

33. The baby monitor of claim 30, wherein the transmitter communicates data to the router operable on an 802.11 standard.

34. The baby monitor of claim 33, wherein the transmitter communicates data to a local monitor.

35. A monitor comprising:
a camera for capturing video images;
a microphone for capturing audio data;
a transmitter to transmit data to (i) a local monitoring device and (ii) to a second device for delivery of the video images and audio data to a third device; and
a controller being connected to the camera, the microphone and the transmitter.
